(19) United States
(12) Patent Application Publication
(10) Pub. No.: US 2024/0175695 A1
(43) Pub. Date: May 30, 2024

(54) INFORMATION PROCESSING DEVICE

(71) Applicant: TOYOTA JIDOSHA KABUSHIKI KAISHA, Toyota-shi (JP)

(72) Inventors: Fumiyuki KAGARA, Sagamihara-shi (JP); Hiroyuki NISHIZAWA, Nagakute-shi (JP); Hirofumi AINO, Kawaguchi-shi (JP)

(73) Assignee: TOYOTA JIDOSHA KABUSHIKI KAISHA, Toyota-shi (JP)

(21) Appl. No.: 18/491,228

(22) Filed: Oct. 20, 2023

(30) Foreign Application Priority Data
Nov. 30, 2022 (JP) 2022-191889

(51) Int. Cl. G01C 21/34

(52) U.S. Cl. CPC G01C 21/3476; G01C 21/343

(57) ABSTRACT

The information processing device includes a storage unit, a communication unit, a time information provision unit, and a control unit. The storage unit stores spot information including location information and time frame information. The communication unit can communicate with information equipment carried by a user and an in-vehicle device mounted on a vehicle on which the user is located, and can acquire current location information of either or both of the information equipment and the vehicle. The time information provision unit provides current time information. The control unit determines a virtual area based on the current location information, extracts a spot located in the virtual area based on the spot information, and determines whether to generate a notification related to the extracted spot based on the location information of the extracted spot, the time frame information associated with the extracted spot, the current location information, and the current time information.

### CROSS-REFERENCE TO RELATED APPLICATION

This application claims priority to Japanese Patent Application No. 2022-191889 filed on Nov. 30, 2022, incorporated herein by reference in its entirety.

### BACKGROUND

### 1. Technical Field

The present disclosure relates to information processing devices.

### 2. Description of Related Art

A system has been proposed that searches for tourist spots located within a predetermined range from a route to a destination, generates stop-off guide information on the route with a found tourist stop added, and displays the stop-off guide information to a user traveling in a vehicle (see, for example, Japanese Unexamined Patent Application Publication No. 2017-194317 (JP 2017-194317 A)).

### SUMMARY

The related art has room for improvement in guiding a user on the move to a tourist spot at an appropriate time.

In view of such circumstances, it is an object of the present disclosure to improve a method for guiding a user on the move to a stop off spot.

An information processing device according to an aspect of the present disclosure includes:
a storage unit configured to store spot information, the spot information including location information of each of a plurality of spots registered or selected by a user and time frame information associated with each of the spots;
a communication unit configured to communicate with information equipment carried by the user and an in-vehicle device mounted on a vehicle in which the user is located, the communication unit being configured to acquire current location information indicating a current location of either or both of the information equipment and the vehicle;
a time information provision unit configured to provide current time information indicating a current time; and
a control unit configured to determine a virtual area based on the current location information, extract a spot located in the virtual area based on the spot information, and determine whether to generate a notification regarding the extracted spot based on the location information of the extracted spot, the time frame information associated with the extracted spot, the current location information, and the current time information.

According to the present disclosure, it is possible to improve a method for guiding a user on the move to a stop-off spot.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a diagram illustrating an example of a virtual area set for a vehicle traveling on a road and a spot located in the virtual area;

FIG. 3 is a flowchart illustrating a procedure of processing executed by the information processing device of FIG. 1;

FIG. 4 is a flowchart of processing for determining whether or not to generate a notification in FIG. 3;

FIG. 5 is a diagram illustrating an exemplary virtual area when a user is moving on foot; and.

FIG. 6 is a diagram illustrating an example of a virtual area when a user is moving on a train.

### DETAILED DESCRIPTION OF EMBODIMENTS

Hereinafter, an embodiment of the present disclosure will be described below with reference to the drawings.

### System Configuration

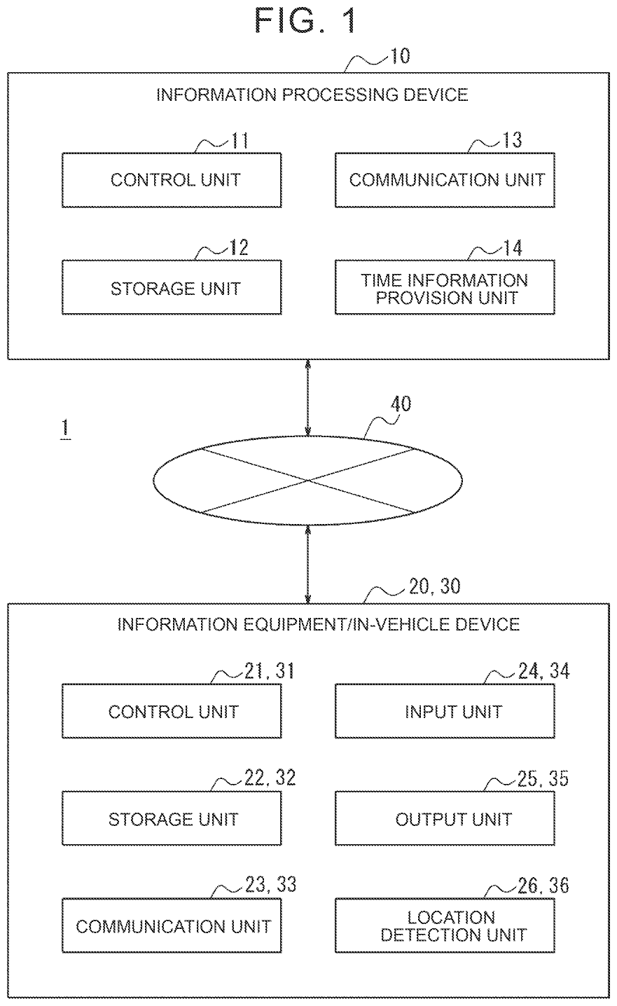

FIG. 1 is a block diagram illustrating a schematic configuration of a system 1 including an information processing device 10 according to an embodiment of the present disclosure. The system 1 includes an information processing device 10, a plurality of pieces of information equipment 20, and an in-vehicle device 30. The information processing device 10, the information equipment 20, and the in-vehicle device 30 can communicate with each other via a network 40 including, for example, the Internet and a mobile communication network. In FIG. 1, for convenience of description, the information equipment 20 and the in-vehicle device 30 are illustrated as one. The functions of the information processing device 10 may be distributed among a plurality of pieces of hardware.

The system 1 is a system that provides information on a surrounding spot to a vehicle, a train, a bicycle, or a user U moving on foot. In the present disclosure, “vehicle” means primarily an automobile, particularly an automobile utilized by an individual user U. Further, in the present disclosure, the “spot” is a place where the user U is a candidate to stop. A “spot” may be referred to as a “stop-off spot.” “Spot” includes restaurants, retail stores, tourist facilities, tourist spots, and the like. The user U registers the spot of interest in the information processing device 10 in advance. Alternatively, the user U selects a spot of interest in advance from a plurality of spots registered in advance in the information processing device 10. The information processing device 10 provides spot information to the information equipment 20 carried by the user U or the in-vehicle device 30 of the vehicle on which the user U is riding when the user U is moving around the spot of interest.

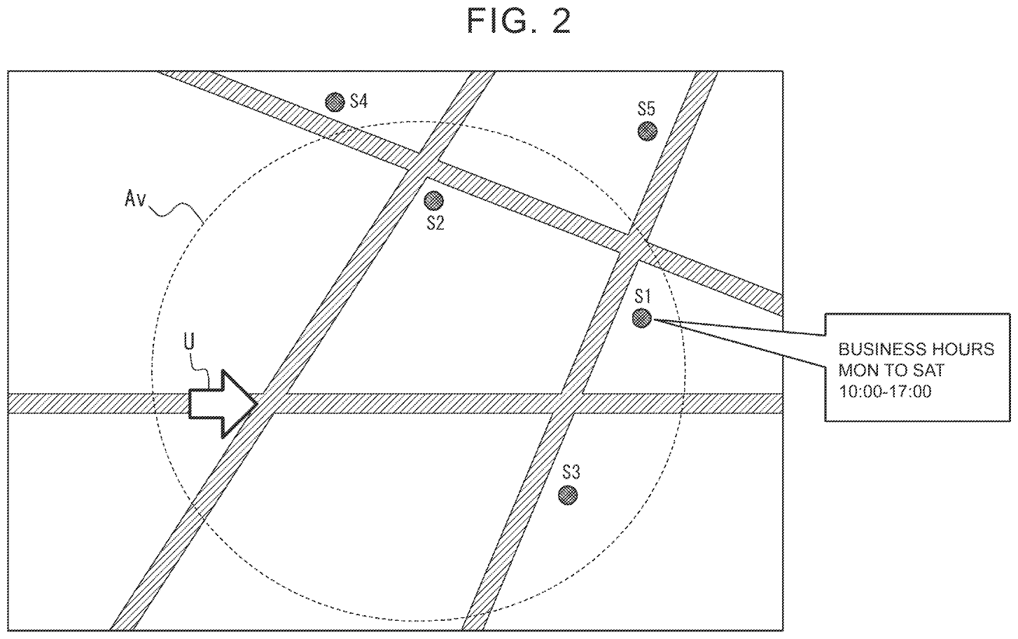

For example, it is assumed that the user U rides on a vehicle and travels on a road. As illustrated in FIG. 2, the information processing device 10 can extract a spot located in the virtual area Av determined based on the current location of the user U to the in-vehicle device 30 of the vehicle in which the user U rides, and provide the information of the spot to the user U. In this way, the user U can get notice of this spot when it has passed near the spot that had been registered in advance with interest for some time, and then visit this spot.

Each component of FIG. 1 will be further described below.

### Information Processing Device

The information processing device 10 is a computer included in a business operator that provides the user U with the functions of the system 1. The information processing device 10 includes a control unit 11, a storage unit 12, a communication unit 13, and a time information provision unit 14.

The control unit 11 includes at least one processor, at least one dedicated circuit, or a combination thereof. A processor is a general-purpose processor such as central processing unit (CPU) or graphics processing unit (GPU), or a special-purpose processor specialized for a particular process. The control unit 11 executes processing related to the operation of the information processing device 10 while controlling each unit of the information processing device 10.

The storage unit 12 includes at least one semiconductor memory, at least one magnetic memory, at least one optical memory, or a combination of at least two types of these memories. The storage unit 12 may function as, for example, a main storage device, an auxiliary storage device, or a cache memory. The storage unit 12 stores programs and data used for the operation of the information processing device 10 and data obtained by the operation of the information processing device 10. The information stored in the storage unit 12 may be updatable by, for example, information acquired from the network 40 via the communication unit 13.

The storage unit 12 of the information processing device 10 stores user information associated with the user U for each user U of the system 1. The user information includes identification information for identifying and authenticating the user U, and spot information of a spot in which the user U is interested. The spot information includes location information of the spot and time frame information associated with the spot. The location information may be represented by longitude and latitude. The time frame information indicates a time frame suitable for the user U to stop by at the spot. The time frame information is, for example, business hours of a restaurant, a store, and a tourist facility, and a time frame suitable for tourism of a tourist spot. For example, in a case where the spot is an outdoor sightseeing place with excellent scenery, a time frame in the daytime from sunrise to sunset may be a time frame suitable for stopping by. Further, for example, in the case where the spot is a sightseeing spot famous for night scenery, the time period from 7:00 pm to 11:00 pm may be the time frame suitable for stopping by. The storage unit 12 further includes map information including road and railway and bus route information. The location of the spot is associated with a location on the map information.

The storage unit 12 may further store, as the user information, available time frame information indicating an available time frame in which the user U is available to stop by at the spot, or no-notification time frame information indicating information on a time frame in which the information of the spot is not notified to the user U set by the information processing device 10 itself. For example, when there is a time frame on a specific day in which the user does not have any particular plans, the user U may register this time frame as available time frame information from the input unit 24 of the information equipment 20. The communication unit 23 of the information equipment 20 may send the available time frame information to the information processing device 10 as controlled by the control unit 21. The control unit 11 of the information processing device 10 may receive the available time frame information of the user U via the communication unit 13 and store the received available time frame information in the storage unit 12. Also, for example, if a user U is using an automobile for commuting, it is considered that the user U does not stop by at any spot even if he or she passes by a spot of interest during the commuting time period. Therefore, the control unit 11 may cause the storage unit 12 to store the commuting time period from Monday to Friday as the no-notification time frame information. The control unit 11 may automatically recognize the no-notification time frame information from the movement pattern of the user U and register it in the storage unit 12. Alternatively, the control unit 11 may store data of the date and time the user U stopped by at any spot in the storage unit 12, and learn the time the user U does not stop by at any spot on the basis of the data. The control unit 11 may add a time frame not included in the no-notification time frame information as an available time frame to the available time frame information.

The communication unit 13 includes at least one external communication interface connected to the network 40. The external communication interface may be either a wired communication or a wireless communication interface.

The communication unit 13 is configured to be able to communicate with the information equipment 20 carried by the user U and the in-vehicle device 30 mounted on the vehicle in which the user U rides. The communication unit 13 is configured to be able to continuously receive the current location information indicating the current location of either or both of the information equipment 20 and the vehicle equipped with the in-vehicle device 30. In the present application, the current location of the information equipment 20 and the vehicle equipped with the in-vehicle device 30 may be expressed as the current location of the user U.

The time information provision unit 14 outputs current time information indicating the current time. The time information provision unit 14 can use a clock built in the information processing device 10.

Note that the information processing device 10 in FIG. 2 of the present embodiment does not describe an input unit and an output unit, but the information processing device 10 may further include an input unit and an output unit. That is, in addition to receiving (inputting) and transmitting (outputting) information via the communication unit 13, the information processing device 10 may input and output information via the input unit and the output unit.

The function of the information processing device 10 is realized by executing a program according to the method of the present disclosure by a processor functioning as the control unit 11. That is, the functions of the information processing device 10 are realized by software. The program causes the computer to execute the operation of the information processing device 10, thereby causing the computer to function as the information processing device 10. That is, the computer functions as the information processing device 10 by executing the operation of the information processing device 10 in accordance with the program.

In the present embodiment, the program can be recorded in a computer-readable recording medium. The computer-readable recording medium includes a non-transitory computer-readable medium such as a magnetic recording device, an optical disc, a magneto-optical recording medium, or a semiconductor memory.

### Configuration of Information Equipment and In-Vehicle Device

The information equipment 20 is an information device used by the user U. The information equipment 20 includes, for example, a smart phone, portable information equipment, a tablet PC, and the like. The in-vehicle device 30 is a computer mounted on a vehicle. The same user U may utilize both the information equipment 20 and the in-vehicle device 30. For example, the user U may use the in-vehicle device 30 when traveling in a vehicle and the information equipment 20 when traveling by walking or public transportation. The in-vehicle device 30 includes a navigation system. The information equipment 20 and the in-vehicle device 30 include common or similar components.

As illustrated in FIG. 1, the information equipment 20 includes a control unit 21, a storage unit 22, a communication unit 23, an input unit 24, an output unit 25, and a location detection unit 26.

The control unit 21 includes at least one processor, at least one dedicated circuit, or a combination thereof. The control unit 21 executes processing related to the operation of the information equipment 20 while controlling each unit of the information equipment 20.

The storage unit 22 includes at least one semiconductor memory, at least one magnetic memory, at least one optical memory, or a combination of at least two types of these memories. The storage unit 22 stores programs and data used for the operation of the information equipment 20 and data obtained by the operation of the information equipment 20. The information stored in the storage unit 22 may be updatable by, for example, information acquired from the network 40 via the communication unit 23. The storage unit 22 may store an application program corresponding to the system 1 and data used in the application.

The communication unit 23 includes at least one external communication interface connected to the network 40. The communication unit 23 receives data used for the operation of the information equipment 20, and transmits data obtained by the operation of the information equipment 20 to the outside (for example, the information processing device 10). The communication unit 23 continuously transmits the current location information detected by the location detection unit 26, which will be described later, to the information processing device 10 under the control of the control unit 21.

The input unit 24 includes at least one input interface. The input interface is, for example, a touch screen integrally provided with a physical key such as a keyboard, a capacitive key, a pointing device, and a display. The input interface may be, for example, a microphone that receives an audio input, a camera that receives an image input, or the like. The input unit 24 receives an operation of inputting data used for the operation of the information equipment 20. Instead of being provided in the information equipment 20, the input unit 24 may be connected to the information equipment 20 as an external input device.

The output unit 25 includes at least one output interface. The output interface is, for example, a display for outputting information in video, a speaker for outputting information in audio, or the like. The display is, for example, an LCD or an organic EL display. The output unit 25 outputs data received from the information processing device 10, data obtained by the operation of the information equipment 20, and the like. The output unit 25 may be connected to the information equipment 20 as an external output device instead of being provided in the information equipment 20.

The location detection unit 26 detects the current location of the information equipment 20. The location detected by the location detection unit 26 may be an absolute location represented by latitude, longitude, or the like. The location detection unit 26 may include a receiver corresponding to the Global Navigation Satellite System (GNSS). The receivers corresponding to GNSS include Global Positioning System (GPS) receivers. The information on the latitude and longitude of the current location of the information equipment 20 can be obtained by using the signal from GPS receiving device.

As illustrated in FIG. 1, the in-vehicle device 30 includes a control unit 31, a storage unit 32, a communication unit 33, an input unit 34, an output unit 35, and a location detection unit 36. The control unit 31, the storage unit 32, the communication unit 33, the input unit 34, the output unit 35, and the location detection unit 36 of the in-vehicle device 30 are the same as or similar to the control unit 21, the storage unit 22, the communication unit 23, the input unit 24, the output unit 25, and the location detection unit 26 of the information equipment 20, respectively, and thus description thereof is omitted. Note that the location information of the in-vehicle device 30 detected by the location detection unit 36 can be regarded as the location information of the vehicle on which the in-vehicle device 30 is mounted.

### Processing Executed by the Control Unit

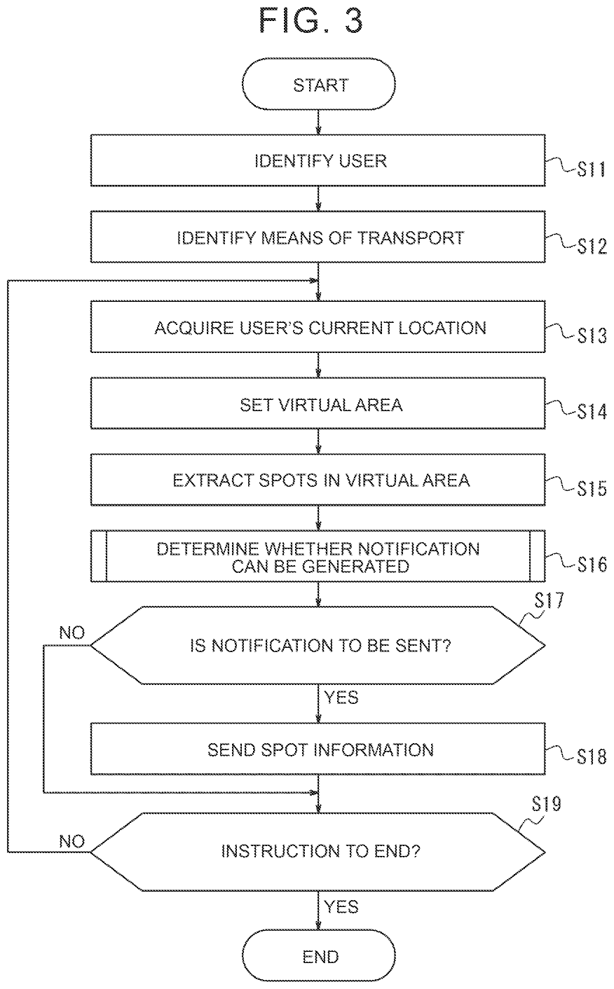

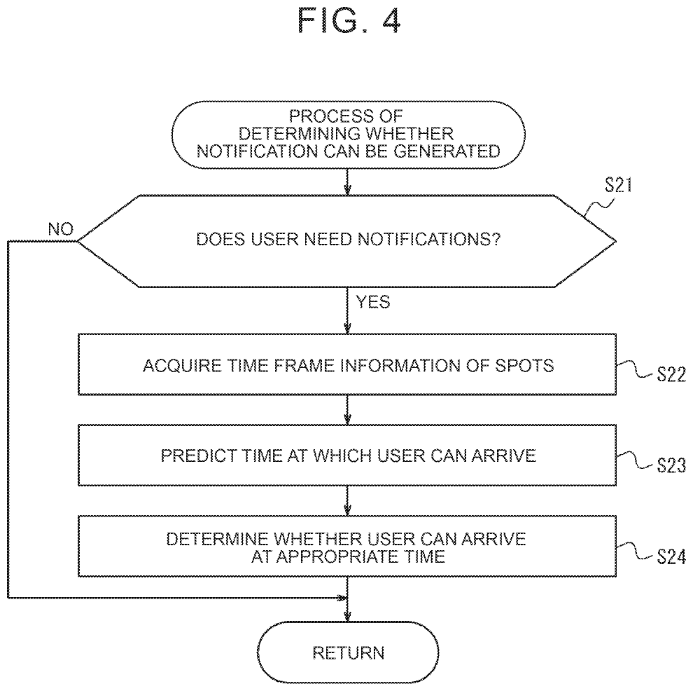

Next, the details of the processing executed by the control unit 11 of the information processing device 10 will be described with reference to the flowcharts of FIGS. 3 and 4. FIG. 3 and FIG. 4 illustrate processing for a particular user U. The control unit 11 executes these processes in parallel for a plurality of users U.

First, the user U launches an application corresponding to the system 1 in the information equipment 20 and/or the in-vehicle device 30. Thereby, the notification of the identification information of the user U from the information equipment 20 and/or the in-vehicle device 30 is received, and the control unit 11 recognizes the user U to be managed (S11). The control unit 11 acquires, from the storage unit 12, user information corresponding to the identification information of the user U that is the management target. Further, the control unit 11 continuously acquires the current location information of the user U via the communication unit 13. Thereafter, the control unit 11 monitors the movement of the user U.

Next, the control unit 11 identifies the moving unit of the user U (S12). When receiving the notification of the identification information of the user U from the in-vehicle device 30, the control unit 11 recognizes that the user is moving by the vehicle. In addition, when receiving the notification from the information equipment 20 of the user, the control unit 11 may determine the current transport mode of the user U from a plurality of transport modes including at least one of the following based on either or both of the moving speed and the current location information of the user: vehicle, train, fixed-route bus, bicycle, and walking. For example, when the moving speed of the user U is equal to or less than 5 km per hour, the control unit 11 may determine that the transport mode of the user U is “walking”. When the trajectory traveled by the user U overlaps with the route of the particular train included in the map information and the moving speed of the user is from 30 km per hour to about 200 km per hour on average, the control unit 11 may determine that the transport mode of the user U is the “train”. Even when the user U uses a bus, since the movement trajectory of the user U overlaps with the route of a fixed-route bus on the road, the transport mode can be determined as a “bus”. When determining that the user U has changed the moving means during the movement, the control unit 11 may change the transport mode as appropriate.

Following S12, the control unit 11 acquires the current location information of the user U via the communication unit 13 (S13). As described above, the control unit 11 continuously acquires the current location of the user U.

The control unit 11 sets the virtual area Av based on the current location information of the user U acquired in S13 (S14). The virtual area Av is an area that is an area for searching for spots. The virtual area Av is determined based on the transport mode. For example, as shown in FIG. 2, when the user U is moving in the vehicle, that is, when the transport mode is “vehicle”, the virtual area Av is a wide area in the traveling direction of the user U. The virtual area Av may be, for example, a circular area centered on a point advanced by the user U for a predetermined period of time. This is because the vehicle proceeds even while the user U is considering stopping at the spot. Therefore, by doing so, the control unit 11 can provide information on a spot in an appropriate range to the user U who is moving in the vehicle.

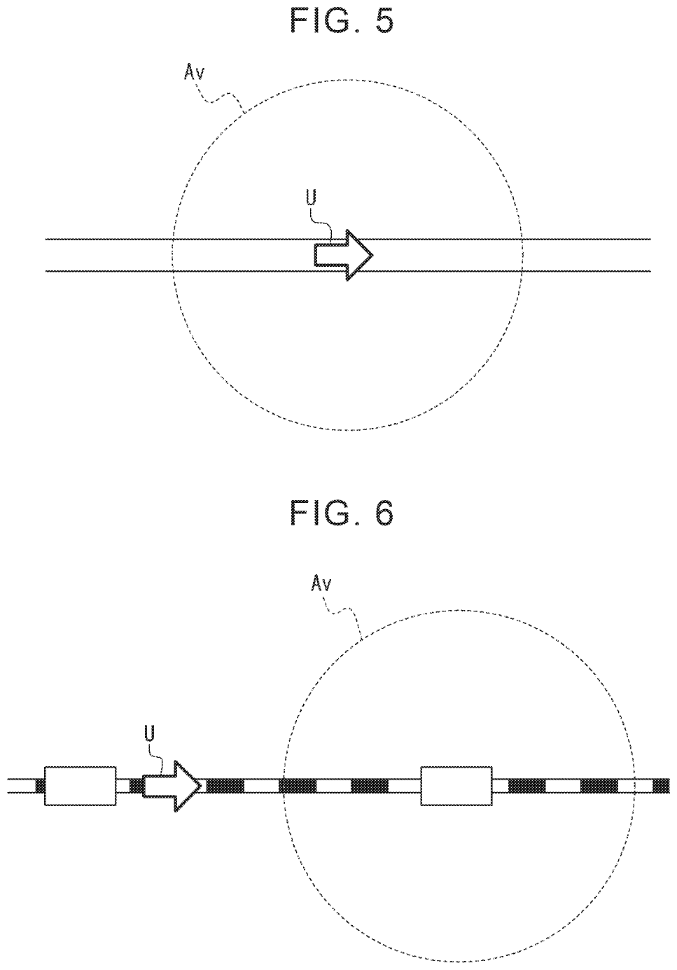

When the user U is moving on foot, that is, when the transport mode is “walking”, the virtual area Av may be a circular region centered on the user U as illustrated in FIG. 5. This is because the user U can stop and consider stopping by at the spot. Therefore, the control unit 11 can provide information on a spot in an appropriate range centered on the current location to the user U who is moving on foot.

The size of the virtual area Av or, if the virtual area Av is circular, its radius may be determined according to the transport mode or the moving speed of the user U. When the transport mode of the user U is “vehicle” and the moving speed is high, the user U can easily stop by at a spot with a relatively long distance. Therefore, the virtual area Av can be widened. On the other hand, when the transport mode is “walking”, the virtual area Av is within a range in which the user U can walk on foot. Therefore, the control unit 11 can present spots in an appropriate range according to the transport mode of the user U.

When the user U is moving on the train, that is, when the transport mode is the “train”, as illustrated in FIG. 6, the virtual area Av can be an area centered on any of the next and subsequent stops of the train. In this case, it is assumed that the user U gets off the train at the next stop to stop by at the spot. Therefore, by presenting the spots around the station to be stopped from now, the control unit 11 can provide the appropriate spot information to the user U moving on the train.

The virtual area Av may be set to have a different-size area for each category of the plurality of spots. The classification of the plurality of spots is a classification including a tourist spot and a restaurant. The classification of the plurality of spots may further include a classification such as a retail store and a tourist facility. The size of the virtual area Av or the radii when the virtual area Av is circular may be different for each category of spots. For example, the size or radius of the virtual area Av may be designated in advance by the user U from the information equipment 20 or the in-vehicle device 30. In this way, spots can be presented according to the user U's preferences such as the user would want to stop by at a restaurant even if it is far, but the user would rather not want to stop by at a retail store if it is far.

The virtual area Av is not limited to a circular area, and may be a quadrangular or other shaped area. The virtual area Av may be an area specified by latitude and longitude.

After S14, the control unit 11 extracts a spot located in the virtual area Av from the spot data stored in the storage unit 12 (S15). For example, in the case of FIG. 2, the control unit 11 extracts S3 from the spot S1 and does not extract the spot S4, S5.

The control unit 11 determines whether the extracted spots may be notified to the user U (S16). S16 determination sequence is shown in FIG. 4.

The control unit 11 acquires available time frame information and/or no-notification time frame information from the user information stored in the storage unit 12, and determines whether or not the user U needs to be notified based on the current time and day of the week information acquired from the time information provision unit 14 (S21). When the current time is a time frame in which the user U does not need notifications (S21:No), the control unit 21 determines not to generate notifications to the user U, and proceeds to S17. When the current time is in a time frame in which the user U needs notifications (S21:Yes), the control unit 11 proceeds to S22 process.

In S22, the control unit 11 acquires the time frame information of the spots extracted from the storage unit 12 in S15.

For each spot, the control unit 11 predicts the time at which the user U can arrive, based on the location information of the spot, the current location information of the user U, and the current time information acquired from the time information provision unit 14 (S23). When predicting the time at which the user U can arrive, the control unit 11 may consider the congestion information of the road toward the location of the spot acquired from an external information source.

Further, the control unit 11 determines whether the user U can arrive at each spot within an appropriate time based on the time at which the user U can arrive as predicted in S23 and the time frame information of the spots (S24). For example, in FIG. 2, it is assumed that the time frame information of the spot S1 indicates the business hours of the store and is 10:00 to 17:00 on Monday to Saturday. If the current time is 16:30, the control unit 11 may determine whether the user U can arrive at the spot S1 by 17:00 when the user U moves to the spot S1 at the shortest distance. In addition, the control unit 11 may consider the shortest stay time required by the user U at the spot. For example, the control unit 11 may determine whether the user U can arrive at the spot S1 by 16:45 on the assumption that the user U needs at least 15 minutes to look around in the store. When the user U can arrive at each spot within an appropriate time, the control unit 11 determines that a notification of the spot may be generated. After S24, the process of the control unit 11 proceeds to S17 of FIG. 3.

If it is determined in S17 that the notification of the spots may be transmitted by S16 (S17:Yes), the process proceeds to S18. On the other hand, when S21 and S24 result indicate that the notification of the spots is not transmitted in S17 (S17:No), the control unit 11 proceeds to S19 process.

In S18, the control unit 11 transmits, to the information equipment 20 or the in-vehicle device 30 via the communication unit 13, a notification related to a spot determined to be able to arrive at an appropriate time in S24. The notification about the spot may include time frame information and additional information on the spot. Additional information may include information such as the date and time the user U registered the spot and/or, if the spot is a store, a commodity famous in the store. When a plurality of spots exist in the virtual area Av, the control unit 11 may transmit information of all the spots or may select and transmit only information of one spot.

Upon receiving the notification from the information processing device 10 via the communication unit 23, the control unit 21 in which the application for the system 1 is operating causes the notification content to be displayed on the display as the output unit 25 in the information equipment 20. For example, a message such as “There is a recommended coffee shop nearby” may be popped up on the display. In addition, a guidance button for activating a route guidance may be displayed together with a message, and when the user U presses this button, the route guidance function of the information equipment 20 may be activated to provide the route guidance to the spot. After S18, the control unit 11 proceeds to S19.

In S19, as long as the information equipment 20 or the in-vehicle device 30 does not receive a signal indicating completion of the processing (S19:No), the information processing device 10 returns to S13 and repeats the processing of S19 from S13. Accordingly, the user U moves and the virtual area Av moves. When the virtual area Av moves and the spot of interest of the new user U enters the virtual area Av, the control unit 11 determines whether it is appropriate to sequentially notify the spot. The control unit 11 notifies the information equipment 20 of the user U or the in-vehicle device 30 of the spot information regarding the spot determined to be appropriate.

On the other hand, in S19, when the information equipment 20 or the in-vehicle device 30 receives a signal indicating the end of the process (S19:No), the information processing device 10 ends the process. When the user U arrives at a preset destination, the information equipment 20 or the application mounted on the in-vehicle device 30 may transmit a signal indicating the end of the processing to the information processing device 10 via the communication units 23 and 33. When the user U terminates the application of the system 1 on the information equipment 20 or the in-vehicle device 30, the control units 21 and 31 may transmit a signal indicating the end of processing to the information processing device 10 via the communication units 23 and 33.

In this way, according to the system 1 of the present disclosure, the output unit 25 of the information equipment 20 of the user U or the output unit 35 of the in-vehicle device 30 displays the information of the spot of interest to the user U when the user U passes around the spot of interest to the user U. This can reduce the possibility of missing the opportunity to stop by at the spot without noticing that the user U is passing near the spot.

In addition, when the current time is included in the available time frame or is not included in the no-notification time frame, the control unit 11 generates and sends a notification related to the spot to the user. Therefore, it is possible to reduce reception of unnecessary notification in a situation where the user does not stop.

Further, in the system 1 of the present disclosure, since the control unit 11 determines the transport mode of the user from the plurality of transport modes and determines the virtual area Av based on the transport mode, it is possible to notify the user of the spots corresponding to the characteristics of the transport mode. Accordingly, it is possible to guide a more appropriate stop-off spot to the user.

It should be noted that the present disclosure is not limited to the above-described embodiments, and many modifications and variations are possible. For example, the functions included in each means, each step, etc. can be rearranged so as not to be logically inconsistent, and a plurality of means, a plurality of steps, etc. can be combined into one or divided.

What is claimed is:

1. An information processing device, comprising:
a storage unit configured to store spot information, the spot information including location information of each of a plurality of spots registered or selected by a user and time frame information associated with each of the spots;
a communication unit configured to communicate with information equipment carried by the user and an in-vehicle device mounted on a vehicle in which the user is located, the communication unit being configured to acquire current location information indicating a current location of either or both of the information equipment and the vehicle;
a time information provision unit configured to provide current time information indicating a current time; and
a control unit configured to determine a virtual area based on the current location information, extract a spot located in the virtual area based on the spot information, and determine whether to generate a notification regarding the extracted spot based on the location information of the extracted spot, the time frame information associated with the extracted spot, the current location information, and the current time information.

2. The information processing device according to claim 1, wherein the control unit is configured to, when the control unit determines that the user is able to arrive at the spot in a time frame included in the time frame information, generate a notification regarding the spot and causes the communication unit to send the notification to the information equipment or the in-vehicle device.

3. The information processing device according to claim 1, wherein the control unit is configured to acquire available time frame information indicating an available time frame in which the user is available to stop by at the spot, and the control unit is configured to determine not to generate the notification regarding the extracted spot when the current time is not included in the available time frame.

4. The information processing device according to claim 1, wherein the control unit is configured to determine a transport mode of the user from a plurality of transport modes including at least one of the following based on information acquired from either or both of the information equipment and the in-vehicle device: vehicle, train, bus, and walking, and determine the virtual area based on the transport mode.

5. The information processing device according to claim 4, wherein the storage unit is configured to store map information, and the control unit is configured to determine the transport mode based on the map information and the current location information.
